(19) United States
(12) Patent Application Publication
(10) Pub. No.: US 2011/0151142 A1
(43) Pub. Date: Jun. 23, 2011

(54) PECVD MULTI-STEP PROCESSING WITH CONTINUOUS PLASMA

(75) Inventors: Martin Jay Seamons, San Jose, CA (US); Sum-Yee Betty Tang, San Jose, CA (US); Michael H. Lin, San Jose, CA (US); Patrick Reilly, Dublin, CA (US); Sudha Rathi, San Jose, CA (US)

(73) Assignee: APPLIED MATERIALS, INC., Santa Clara, CA (US)

(21) Appl. No.: 12/969,333

(22) Filed: Dec. 15, 2010

Related U.S. Application Data
(60) Provisional application No. 61/289,300, filed on Dec. 22, 2009.

(51) Int. Cl. H05H 1/24

(52) U.S. Cl. 427/579; 427/569

(57) ABSTRACT

Embodiments of the present invention provide methods for reducing defects during multi-layer deposition. In one embodiment, the method includes exposing the substrate to a first gas mixture and an inert gas in the presence of a plasma to deposit a first material layer on the substrate, terminating the first gas mixture when a desired thickness of the first material is achieved while still maintaining the plasma and flowing the inert gas, and exposing the substrate to the inert gas and a second gas mixture that are compatible with the first gas mixture in the presence of the plasma to deposit a second material layer over the first material layer in the same processing chamber, wherein the first material layer and the second material layer are different from each other.

### CROSS-REFERENCE TO RELATED APPLICATIONS

This application claims benefit of U.S. provisional patent application Ser. No. 61/289,300, filed Dec. 22, 2009, which is incorporated by reference herein.

### BACKGROUND OF THE INVENTION

1. Field of the Invention

Embodiments of the present invention generally relate to the fabrication of integrated circuits. In particular, embodiments of the present invention relate to method for reducing defects during multi-layer deposition within a processing chamber.

2. Description of the Related Art

In the manufacture of integrated circuits, chemical vapor deposition processes are often used for deposition or etching of various material layers. Conventional thermal CVD processes supply reactive compounds to the substrate surface where heat-induced chemical reactions take place to produce a desired layer. Plasma enhanced chemical vapor deposition (PECVD) processes employ a power source (e.g., radio frequency (RF) power or microwave power) coupled to a deposition chamber to increase dissociation of the reactive compounds. Thus, PECVD processes is a prolific and cost effective method for fast growth of materials of good quality at lower substrate temperatures (e.g., about 75° C. to 650° C.) than those required for analogous thermal processes. This is advantageous for processes with stringent thermal budget demands. For example, in the manufacturing of silicon wafer based microelectronics such as microprocessors, dynamic random access memory (DRAM), NAND Flash memory and NOR Flash memory, the use of PECVD process for thin film deposition is ubiquitous for the above reasons.

Modern photolithographic techniques often involve the use of equipment known as steppers, which are used to mask and expose photoresist layers. Steppers often use monochromatic (single-wavelength) radiant energy (e.g., monochromatic light), enabling them to produce the detailed patterns required in the fabrication of fine geometry devices. As a substrate is processed, however, the topology of the substrate's upper surface becomes progressively less planar. This uneven topology can cause reflection and refraction of the incident radiant energy, resulting in exposure of some of the photoresist beneath the opaque portions of the mask. As a result, this uneven surface topology can alter the patterns transferred by the photoresist layer, thereby altering critical dimensions of the structures fabricated.

One of the approaches helpful in achieving the necessary dimensional accuracy is the use of a dielectric antireflective coating (DARC), usually a thin layer of silicon oxynitride (SiOₓN_{y}), silicon oxide (SiOx) or silicon nitride (SiNₓ). The DARC has been found to have desirable photolithographic properties. The formation of DARCs necessitates the reliable control of optical and physical film parameters such as film's refractive index (n), absorption coefficient (k), and thickness (t). Generally, the optical characteristics of a DARC are chosen to minimize the effects of reflections occurring at interlayer interfaces during the photolithography process. The DARC's absorption coefficient (k) is such that the amount of radiant energy transmitted in either direction is minimized, thus attenuating both transmitted incident radiant energy and reflections thereof. The DARC's refractive index (n) is matched to that of the associated photoresist material in order to reduce refraction of the incident radiant energy.

A DARC be formed, for example, by a thermal CVD process or PECVD process as discussed above to promote excitation and/or disassociation of the reactant gases. Deposition of a DARC film necessarily involves a unique pressure, electrode spacing, plasma power setpoint, gas flow rate, total gas flow, and the substrate temperature. The typical method for the deposition of each film involves stabilizing the wafer temperature, pressure, gas flows, and setting the electrode spacing, and then igniting the plasma. When the desired amount of film is deposited, the plasma is extinguished to terminate the deposition, and then the processing chamber is evacuated of all volatile species.

When depositing multiple films in the same processing chamber, the conditions for the first film deposition need to be established and plasma is ignited to deposit the first film, and then the plasma terminated. Thereafter, the conditions for the second film deposition are established and the plasma is ignited to deposit the second film, and then the plasma terminated. This procedure may continue for two or more layers until the desired film stack is deposited. However, this conventional method allows for particles to contaminate the substrate at the end of every deposition since no repulsive force (e.g., van der waals force) is presented between the substrate and particles when plasma is extinguished, causing unwanted particles to adsorb or fall on the substrate during the transition between subsequent layers.

In addition, unwanted defects or particles may also be formed due to the presence of incompletely reacted species on the surface of a deposited layer. During subsequent deposition to form overlying layers in the stack, these incompletely reacted materials may serve as nucleation sites for reactions with reactant of subsequent PECVD steps. The resulting defects at the bottom interface may be decorated with the subsequent films and become larger defects. These defects generally are not detectable until they become larger defects after many layers have been deposited. As a simplified cross-sectional sketch of a dielectric stack shown in FIG. 4, one or more defects 402 that initially appeared at the bottom interface are decorated to larger defects 404 during multiple deposition of a dielectric stack. After many layers have been deposited, defects (indicated as 406) may be large enough to alter the topography or affect the film property of a dielectric stack, thereby compromising performance of active electronic devices incorporating the stack.

Therefore, a need exists for a method of reducing defect formation on the substrate during multi-layer deposition within a processing chamber.

### SUMMARY OF THE INVENTION

Embodiments of the present invention provide methods for reducing defects during multi-layer deposition. In one embodiment, the method includes exposing the substrate to a first gas mixture and an inert gas in the presence of a plasma to deposit a first material layer on the substrate, terminating the first gas mixture when a desired thickness of the first material is achieved while maintaining the plasma and flowing only the inert gas, and exposing the substrate to the inert gas and a second gas mixture that are compatible with the first gas mixture in the presence of the plasma to deposit a second material layer over the first material layer in the same processing chamber without moving the substrate, wherein the first material layer and the second material layer are different from each other.

In another embodiment, a method for processing a substrate disposed within a processing chamber includes providing a first gas mixture by flowing one or more precursor gases and an inert gas to the chamber, applying an electric field to the gas mixture and heating the gas mixture to decompose the one or more precursor gases in the gas mixture to generate a plasma, depositing the first material on the substrate until a desired thickness of the first material is achieved, terminating at least one gas flow of the one or more precursor gases in the first gas mixture while flowing only the inert gas and maintaining the plasma, stabilizing a process condition for a second material within the processing chamber, providing a second gas mixture by flowing one or more precursor gases to the same processing chamber, wherein the first gas mixture and the second gas mixture are compatible to each other, and depositing over the first material a second material that is different from the first material.

In yet another embodiment, a method for reducing defects during multi-layer deposition within a processing chamber includes exposing the substrate to a first gas mixture in the presence of a plasma to deposit a first material layer on the substrate, terminating the first gas mixture while still continuously igniting the plasma, stabilizing a processing condition within the processing chamber, exposing the substrate to a second gas mixture that is compatible with the first gas mixture in the presence of the plasma to deposit a second material layer over the first material layer in the same processing chamber, and terminating the second gas mixture and pumping out any gas or plasma generated in the processing chamber.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an exemplary vacuum processing system that is suitable for practicing one embodiment of the present invention.

FIG. 2 is a cross-sectional view of an exemplary processing chamber that is suitable for practicing one embodiment of the present invention.

FIG. 3 is a process flow diagram illustrating an embodiment of the present invention.

FIG. 4 depicts defects that initially appeared at the bottom interface are decorated to larger defects during multi-layer deposition when forming a dielectric stack.

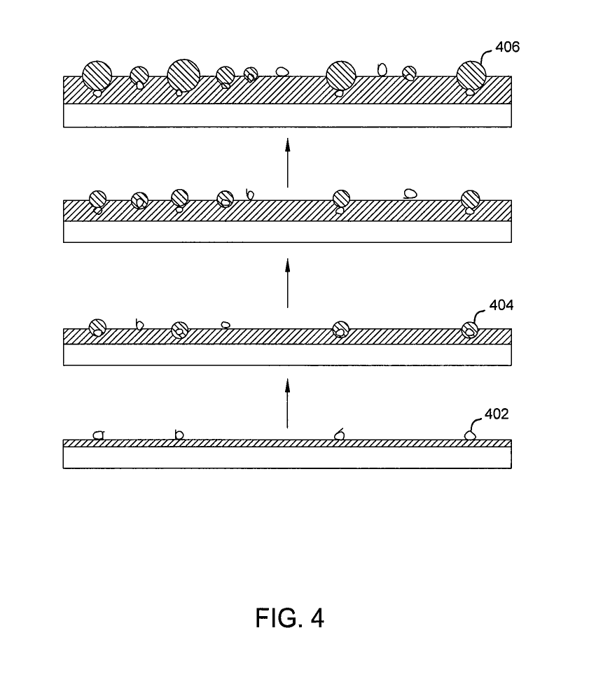

### DETAILED DESCRIPTION

The present invention provides a method for reducing defects formed during multi-layer deposition within a processing chamber. Films that can benefit from this process include dielectric materials such as silicon oxide, silicon oxynitride, or silicon nitride films that may be used as a dielectric antireflective coating (DARC). In one embodiment, the defect control is realized by maintaining a continuous plasma between each deposition step such that any particles formed during the previous deposition or flaking off from the surfaces of the processing chamber are suspended in the plasma, preventing unwanted particles from falling on the substrate. The unwanted particles will remain suspending in the plasma until the final layer deposition is finished and be removed by a purging and pumping steps to minimize chances of contaminating the substrate during the entire deposition process. In another embodiment, an inert gas is continuously flowing into the processing chamber to maintain the plasma during the transition between each deposition steps. Meanwhile, in a back-to-back deposition process, the precursor gas(es) used for the subsequent film is compatible with the precursor gas(es) for the previous film to maintain stable processing conditions during the transition stage.

### Exemplary Hardware Overview

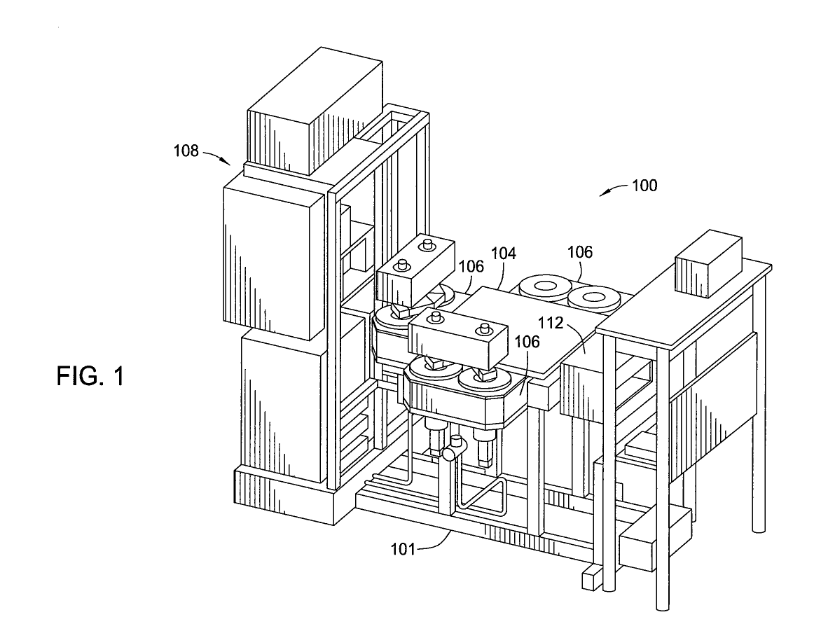

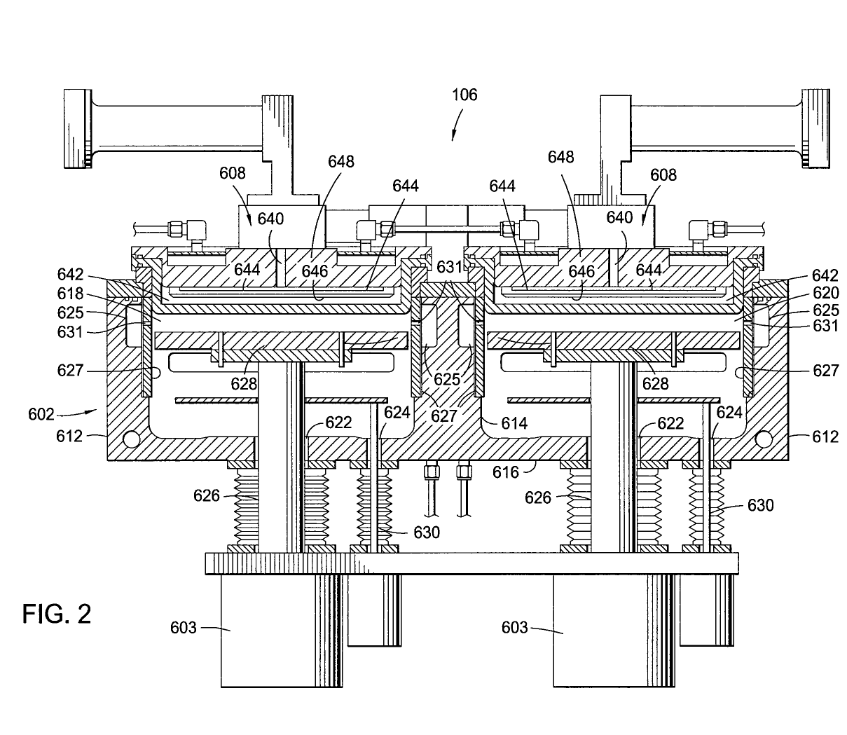

FIG. 1 is a perspective view of a vacuum processing system that is suitable for practicing embodiments of the invention. FIG. 2 is a cross-sectional schematic view of a chemical vapor deposition (CVD) chamber 106 that is suitable for practicing embodiments of the invention. One example of such a chamber is a PRODUCER® dual chambers or a DxZ® chamber, used in a P-5000 mainframe or a CENTURA® platform, suitable for 200 mm, 300 mm, or larger size substrates, all of which are available from Applied Materials, Inc., of Santa Clara, Calif. In FIG. 1, the system 100 is a self-contained system supported on a main frame structure 101 where wafer cassettes are supported and wafers are loaded into and unloaded from a loadlock chamber 112, a transfer chamber 104 housing a wafer handler, a series of tandem process chambers 106 mounted on the transfer chamber 104 and a back end 108 which houses the support utilities needed for operation of the system 100, such as a gas panel, power distribution panel and power generators. The system can be adapted to accommodate various processes and supporting chamber hardware such as CVD, PVD and etch. The embodiment described below will be directed to a system employing a CVD process, such as plasma enhanced CVD processes, to deposit one or more materials.

FIG. 2 shows a schematic cross-sectional view of the chamber 106 defining two processing regions 618, 620. The chamber body 602 includes chamber sidewall 612, chamber interior wall 614 and chamber bottom wall 616 which define the two processing regions 618, 620. The bottom wall 616 in each processing region 618, 620 defines at least two passages 622, 624 through which a stem 626 of a heater pedestal 628 and a rod 630 of a wafer lift pin assembly are disposed, respectively.

The chamber 106 also includes a gas distribution system 608, typically referred to as a “showerhead”, for delivering gases into the processing regions 618, 620 through a gas inlet passage 640 into a shower head assembly 642 comprised of an annular base plate 648 having a blocker plate 644 disposed intermediate a face plate 646. A plurality of vertical gas passages are also included in the shower head assembly 642 for each reactant gas, carrier/inert gas, and cleaning gas to be delivered into the chamber through the gas distribution system 608.

A substrate support or heater pedestal 628 is movably disposed in each processing region 618, 620 by a stem 626 which is connected to a lift motor 603. The stem 626 moves upwardly and downwardly in the chamber to move the heater pedestal 628 to position a substrate (not shown) thereon or remove a substrate there from for processing. Gas flow controllers are typically used to control and regulate the flow rates of different process gases into the process chamber 106 through gas distribution system 608. Other flow control components may include a liquid flow injection valve and liquid flow controller (not shown) if liquid precursors are used. A substrate support is heated, such as by a heater having one or more resistive elements, and is mounted on the stem 626, so that the substrate support and the substrate can be controllably moved by a lift motor 603 between a lower loading/off-loading position and an upper processing position adjacent to the gas distribution system 608.

The chamber sidewall 612 and the chamber interior wall 614 define two cylindrical annular processing regions 618, 620. A circumferential pumping channel 625 is formed in the chamber walls for exhausting gases from the processing regions 618, 620 and controlling the pressure within each region 618, 620. A chamber insert or liner 627, preferably made of ceramic or the like, is disposed in each processing region 618, 620 to define the lateral boundary of each processing region and to protect the chamber sidewalls 612 and the chamber interior wall 614 from the corrosive processing environment and to maintain an electrically isolated plasma environment. A plurality of exhaust ports 631, or circumferential slots, are located about the periphery of the processing regions 618, 620 and disposed through each liner 627 to be in communication with the pumping channel 625 formed in the chamber walls and to achieve a desired pumping rate and uniformity. The number of ports and the height of the ports relative to the face plate of the gas distribution system are controlled to provide an optimal gas flow pattern over the wafer during processing.

A plasma is formed from one or more process gases or a gas mixture by applying an electric field from a power supply and heating the substrate, such as by the resistive heater element. The electric field is generated from coupling, such as inductively coupling or capacitively coupling, to the gas distribution system 608 with radio-frequency (RF) or microwave energy. In some cases, the gas distribution system 608 acts as an electrode. Film deposition takes place when the substrate is exposed to the plasma and the reactive gases provided therein. The substrate support and chamber walls are typically grounded. The power supply can supply either a single or mixed-frequency RF signal to the gas distribution system 608 to enhance the decomposition of any gases introduced into the chamber 106. When a single frequency RF signal is used, e.g., between about 350 kHz and about 60 MHz, a power of between about 1 and about 2,000 W can be applied to the gas distribution system 608.

A system controller controls the functions of various components such as the power supplies, lift motors, flow controllers for gas injection, vacuum pump, and other associated chamber and/or processing functions. The system controller executes system control software stored in a memory, which in one embodiment is a hard disk drive, and can include analog and digital input/output boards, interface boards, and stepper motor controller boards. Optical and/or magnetic sensors are generally used to move and determine the position of movable mechanical assemblies. A similar system is disclosed in U.S. Pat. No. 5,855,681, entitled “Ultra High Throughput Wafer Vacuum Processing System,” issued to Maydan et al., filed on Nov. 18, 1996, also in U.S. Pat. No. 6,152,070, entitled “Tandem Process Chamber,” issued to Fairbairn et al., filed on Nov. 18, 1996. Both are assigned to Applied Materials, Inc., the assignee of the present invention. Another examples of such a CVD process chamber is described in U.S. Pat. No. 5,000,113, entitled “Thermal CVD/PECVD Reactor and Use for Thermal Chemical Vapor Deposition of Silicon Dioxide and In-situ Multi-step Planarized Process,” issued to Wang et al., and in U.S. Pat. No. 6,355,560, entitled “Low Temperature Integrated Metallization Process and Apparatus,” issued to Mosely et al. and assigned to Applied Materials, Inc. The aforementioned patents are hereby incorporated by reference to the extent not inconsistent with the disclosure herein. The above CVD system description is mainly for illustrative purposes, and other plasma processing chambers may also be employed for practicing embodiments of the invention.

### Exemplary Deposition Process

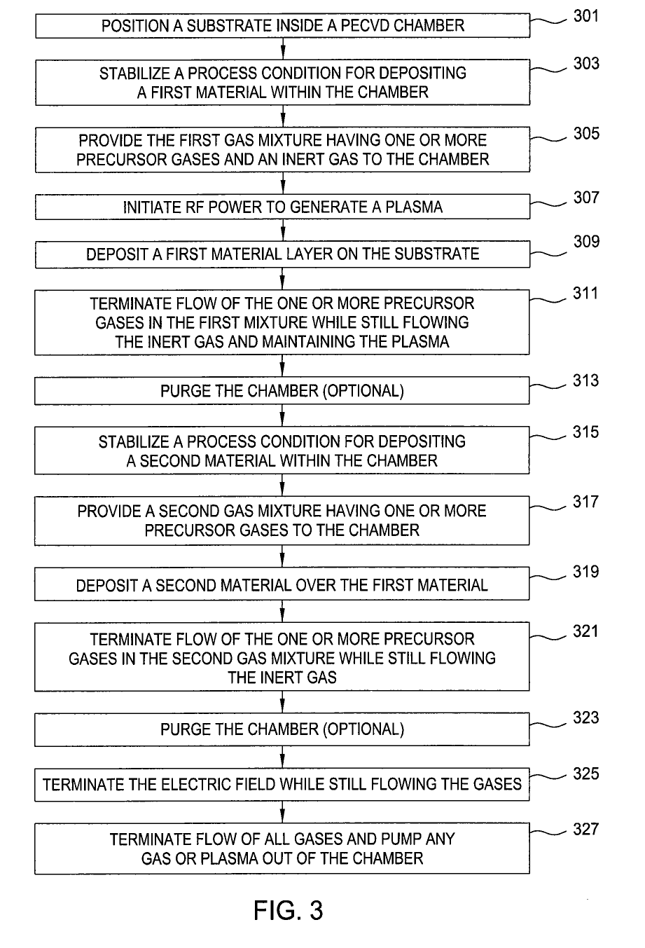

FIG. 3 is a process flow diagram illustrating an embodiment of the present invention. The process begins with start step 301 that includes placing a substrate into a processing chamber, for example, the PECVD chamber as described above in conjunction with FIGS. 1 and 2. The substrate may be, for example, a silicon substrate, a germanium substrate, a silicon-germanium substrate, and the like. The substrate may include a plurality of already formed layers or features such as a via, interconnect, or gate stack formed over the base substrate material.

At step 303, the processing chamber is stabilized to establish a process condition that is suitable for a desired material to be deposited on the substrate. The stabilization may include adjusting the process parameters necessary to operate the processing chamber for performing a desired deposition. The process parameters may include, but not limited to setting up process conditions such as, for example, process gas composition and flow rates, total gas flow, pressure, electrode spacing (i.e., the spacing between the showerhead and the substrate support), plasma power, and substrate temperature, etc.

At step 305, a first gas mixture is introduced into the processing chamber for the deposition of a desired material, such as a first dielectric layer, on the substrate. The first gas mixture may include various process gas precursors, carrier and/or inert gases for depositing the dielectric layer. For example, in the deposition of a silicon oxide film, the first gas mixture may include a process gas precursor such as silane (SiH₄), an oxygen source gas, e.g., carbon dioxide (CO₂) or nitrous oxide (N₂O), and an inert gas, e.g., helium. In one example, a SiH₄ gas at a flow rate of about 585 sccm, a CO₂ gas at a flow rate of about 7000 sccm, a helium gas at a flow rate of about 7000 sccm, among others (e.g., doping atoms, if desired), are introduced into the processing chamber for a desired period of time such as between about 0.1 seconds and about 120 seconds, for the deposition of the silicon oxide layer. In one example, the first gas mixture is flowed into the processing chamber for about 5 seconds. Optionally, the oxygen source gas may be introduced into the processing chamber with an inert gas, such as argon or helium, to enhance plasma stability and uniformity in the chamber. Although not discussed here, additional process gases may be also added to control or improve the film properties. For example, when a silicon oxide dielectric layer is used, nitrogen, in the form of nitrogen-containing substances such as nitrogen (N₂) or nitrous oxide (N₂O), may be added to the silicon oxide layer to alter the layer's optical properties. This permits accurate control of the film's optical parameters such as refractive and absorptive indexes.

The inert gas or oxygen source gas as described here may vary depending upon the application. The oxygen source gas is not limited to carbon dioxide. Other oxygen-containing gases such as O₂, O₃, N₂O and combination thereof may be used. Similarly, the inert gas may be chosen based on the deposition to be performed in the processing chamber. For example, helium may be used as the inert gas for depositing low dielectric constant films comprising silicon, oxygen, carbon, and hydrogen, while argon may be used as the inert gas for depositing amorphous carbon films or films comprising silicon and carbon, but not oxygen. The inert gas helps stabilize the pressure in the processing chamber or in the remote plasma source and assists in transporting the reactive species to the processing chamber. It is contemplated that other inert gases can be used for depositing any of the films as will be discussed below.

It is also contemplated that other silicon-containing gases other than silane may be used for depositing the first dielectric layer. For example, the silicon-containing gases may include, but not limited to disilane (Si₂H₆), tetrafluorosilane (SiF₄), dichlorosilane, trichlorosilane, dibromosilane, silicon tetrachloride, silicon tetrabromide, or combinations thereof. Alternatively, organic silicon-containing precursors such as trisilylamine (TSA), tetraethylorthosilicate (TEOS), or octamethylcyclotetrasiloxane (OMCTS), etc., depending upon the application.

DARC using silicon oxide as described above is one of the exemplary embodiments for photolithography application and should not be considered as a limitation. For example, silicon oxynitride (SiOₓN_{y}) may be a favorable candidate for DARC because of the ease with which such a process may be integrated with other substrate processing operations, and the material's well-understood optical qualities and process parameters. In such a case, the process gas precursors may include, for instance, silane and nitrous oxide. Dielectric materials of the first dielectric layer that can benefit from the present invention may include, but not limited to silicon nitride, silicon carbide, or silicon oxycarbide layer. The DARC layer may be a silicon-rich oxide, silicon-rich nitride, silicon-rich oxynitride, hydrogen-rich silicon nitride, carbon-doped silicon oxide, oxygen or nitrogen-doped silicon carbide, amorphous silicon or carbon (either un-doped or doped with N, B, F, O), or porous or densified versions of all these films, depending on the application or film properties needed such as refractive index or mass density. The precursor gas may vary depending upon the dielectric materials to be deposited. For example, when amorphous carbon is desired, the gas mixture may include various process gas precursors such as one or more hydrocarbon compounds, various carrier gases such as argon, and inert gases. Depending upon the application, the hydrocarbon compounds may be partially or completely doped derivatives of hydrocarbon compounds. In one example, the derivatives include nitrogen-, fluorine-, oxygen-, hydroxyl group-, and boron-containing derivatives of hydrocarbon compounds.

At step 307, RF power is initiated in the processing chamber in order to provide plasma processing conditions in the chamber. The first gas mixture is reacted in the processing chamber in the presence of RF power to deposit the first dielectric layer having materials as previously discussed on the substrate, as shown in step 309. The plasma during step 307 may be provided at a power level between about 25 W and about 3000 W at a frequency of 13.56 MHz. In one example, the plasma is provided at a power level between about 25 W and about 200 W, such as about 150 W. The RF power may be provided to a showerhead, i.e., a gas distribution system 608 as illustrated in FIG. 2, and/or a heater pedestal 628 of the processing chamber. During this step, the spacing between the showerhead and the substrate support may be greater than about 230 mils, such as between about 350 mils and about 800 mils. In one example, the spacing is about 520 mils. Meanwhile, the chamber temperature and pressure may be maintained about 400° C. and about 2 Torr to about 10 Torr, respectively.

At step 311, the flow of the one or more process gas precursors, for example, silane, is terminated while still flowing the inert gas in the gas mixture. In one example, the inert gas, such as a helium gas, is maintained between about 1 second and 1 minute, such as between about 5 seconds and about 10 seconds. Since the process gas precursor is terminated, a continuous flowing of inert gas helps purge particles away from the substrate surface while making sure that there will not be a significant amount of unwanted deposition happening on the substrate during this transition stage. In addition, by terminating the flow of silane immediately after the first dielectric layer is deposited on the substrate, the source of the particle contamination is reduced inside the processing chamber, thereby lowering the chance for particles to fall down onto the substrate surface.

While terminating the flow of the process gas precursor, the RF power in this embodiment is still maintained during the step 311 such that the plasma is continuously ignited. The inventors have observed that a continuous plasma after the dielectric layer is deposited will significantly reduce the chance of substrate contamination. This is because the particles formed during the deposition will remain negatively charged and suspended in the plasma due to repulsive force between particles and the negatively biased substrate surface, thereby preventing unwanted particles from falling onto the substrate surface. In addition, by using continuous plasma between each deposition, reactive species present in non-stoichiometric and non-equilibrium concentrations can be completely reacted to form part of the film instead of agglomerating to form particles that will fall on top of the substrate when the plasma is extinguished.

Thereafter, while the RF power is still on, an optional purging step 313 may be performed by introducing a purging gas, such as helium gas, into the processing chamber for a desired period of time to purge any remaining precursor gases from the processing chamber. The purging gas may be introduced into the processing chamber at a flow rate of between about 100 sccm and about 20,000 sccm. The purging gas may be flowed into the processing chamber for a period of time such as between about 0.1 seconds and about 60 seconds. The pressure of the processing chamber may be between about 5 mTorr and about 10 Torr, and the temperature of a substrate support in the processing chamber may be between about 125° C. and about 580° C. while the purging gas is flowed into the processing chamber. In one example, the purging gas, such as helium gas, is flowed into the processing chamber for about 5 seconds at a flow rate of about 7,000 sccm. The chamber pressure may be about 2 Torr and the temperature of the substrate support is about 400° C. It should be noted by one of ordinary skill in the art that the flow rates of process gas precursors, carrier gases, inert gases, or other processing conditions provided in this disclosure may be adjusted accordingly upon the size of the substrate and the volume of the deposition chamber.

At step 315, after the optional purging step, the processing chamber may be stabilized to establish a process condition that is suitable for deposition of a desired material, such as a second dielectric layer, on the substrate. Similar to step 303, the stabilization may include adjusting the process parameters necessary to operate the processing chamber for performing the second dielectric layer. The process parameters may include, but not limited to setting up process conditions such as, for example, process gas composition, flow rates, total gas flow, pressure, electrode spacing, plasma power, and substrate temperature, etc. During the transition stage between each deposition, the plasma instability may easily occur as a result of an adjustment of gas flow, chamber pressure, or RF power since the plasma is very sensitive. For example, changing to a low pressure with high power and low electrode spacing may cause arcing, which can have detrimental effects to the equipment or the film property. To this end, it is important to keep the process parameters within a desired process window during this transition stage between each deposition. In addition, since the processing parameters for the next deposition is known, even when a very high power (e.g., about 2.4 GHz) is used, the electrode spacing, chamber pressure, and other process parameters can be adjusted accordingly in advance to work with the desired high power without causing arcing or any unwanted damage to the film deposition.

At step 317, a second gas mixture is introduced into the processing chamber for the deposition of a desired material, such as a second dielectric layer, on the substrate, as shown in step 319. The second gas mixture may include various process gas precursors, carrier and/or inert gases for depositing the second dielectric layer. For example, in the deposition of a silicon nitride film, the second gas mixture may include a process gas precursor such as silane (SiH₄), ammonia (NH₃), and in some cases nitrogen (N₂). In one example, a SiH₄ gas at a flow rate of about 100-500 sccm, an ammonia gas at a flow rate of about 100-4000 sccm, among others (e.g., doping atoms, if desired), are introduced into the processing camber for a desired period of time such as between about 0.1 seconds and about 120 seconds, for the deposition of the silicon nitride layer. In one example, the second gas mixture is flowed into the processing chamber for about 5 seconds.

Thereafter, the RF power is initiated in the processing chamber in order to provide plasma processing conditions in the chamber. The second gas mixture is reacted in the processing chamber in the presence of RF power to deposit the second dielectric layer having materials as will be discussed below on the substrate. The plasma during step 319 may be provided at a power level between about 10 W and about 3000 W at a frequency of 13.56 MHz. In one example, the plasma is provided at a power level between about 25 W and about 200 W, such as about 150 W. The RF power may be provided to a showerhead and/or a substrate support of the processing chamber. During this step, the spacing between the showerhead and the substrate support may be greater than about 230 mils, such as between about 350 mils and about 800 mils. In one example, the spacing is about 450 mils. Meanwhile, the chamber temperature and pressure may be maintained about 400° C. and about 2 Torr to about 10 Torr, respectively.

The second gas mixture may further include a carrier gas, such as helium, during the transition stage between the first dielectric layer deposition and the second dielectric layer deposition. In one example, the helium gas may be flowed into the processing chamber at a flow rate of between about 7000 sccm and about 20,000 sccm. The timing of flowing process gas precursors into the processing chamber for depositing the first and second dielectric layers may vary upon the application. In one example where the first dielectric layer is silicon oxide and the second dielectric layer is silicon nitride, it may be desirable to maintain the helium plasma while ramping down the nitrous oxide flow and ramping up the ammonia or nitrogen flow. Alternatively, there may be a time lag before switching from nitrous oxide flow to ammonia or nitrogen flow.

It is contemplated that other silicon-containing gases other than silane may be used for depositing the second dielectric layer. For example, the silicon-containing gases may include, but not limited to disilane (Si₂H₆), tetrafluorosilane (SiF₄), dichlorosilane, trichlorosilane, dibromosilane, silicon tetrachloride, silicon tetrabromide, or combinations thereof. Alternatively, organic silicon-containing precursors such as trisilylamine (TSA), tetraethylorthosilicate (TEOS), or octamethylcyclotetrasiloxane (OMCTS), etc., may also be used depending upon the application. Similarly, any nitrogen-containing gases other than ammonia may be used. For example, the nitrogen-containing gases may include, but not limited to nitrous oxide (N₂O), nitric oxide (NO), nitrogen gas (N₂), combinations thereof, or derivatives thereof.

Dielectric materials of the second dielectric layer that can benefit from the present invention may include, but not limited to silicon oxide, silicon carbide, or silicon oxycarbide layer. The DARC layer may be a silicon-rich oxide, silicon-rich nitride, silicon-rich oxynitride, hydrogen-rich silicon nitride, carbon-doped silicon oxide, oxygen or nitrogen-doped silicon carbide, amorphous silicon or carbon (either un-doped or doped with N, B, F, O), or porous or densified versions of all these films, depending on the application or film properties needed such as refractive index or mass density. Although silicon nitride is discussed here as an example for the second dielectric layer, other dielectric materials suitable for photolithograph application may also be used. When multiple layers of different dielectric films is desired in a back-to-back deposition process, it is preferable that the precursor gas(es) used for the subsequent dielectric layer is compatible with the precursor gas(es) for the previous dielectric layer, so that any changes during the transition stage between each film deposition is smooth and less detrimental to the film property. In this embodiment, for example, if silane is used as a main precursor gas to deposit the first dielectric layer such as silicon oxide, silicon oxynitride, or silicon nitride, then the precursor gas for depositing the second dielectric layer should preferably be within silane family such as monosilane (SiH₄), disilane (Si₂H₆), trisilane (Si₃H₈), dichlorosilane (SiH₂Cl₂), or trichlorosilane (SiHCl₃). Another family of films that might be chemistry compatible to each other is TetraEthylOrthoSilicate (TEOS) based silicon oxide film plus boron and/or phosphous doped TEOS based silicon oxide, or TEOS based undoped silicon oxide film plus flourine doped TEOS based silicon oxide film, etc.

At step 321, the RF power and flowing of the one or more process gas precursors, for example, silane, is terminated, to make sure that there will not be a significant amount of unwanted deposition happening on the substrate. In one embodiment, the flow of an inert gas may be continued for a desired period of time to help purge unwanted particles away from the substrate surface. In one example, the flow of the inert gas, such as helium gas, may be maintained for about 1 second to about 1 minute, such as between about 5 seconds and about 180 seconds. In one another embodiment, the inert gas is terminated prior to deposition of the second dielectric layer, for example, prior to the stabilization step used to establish a suitable process condition for deposition of the second dielectric layer.

At step 323, an optional purging step similar to step 313 is performed by introducing a purging gas into the processing chamber for a desired period of time to purge out remaining precursor gases or inert gas of the processing chamber.

At step 325, the RF power remained on during step 323 is terminated while gases such the inert gas are still flowing. Alternatively, the RF power may be terminated prior to terminating the inert gas and pumping out step.

At step 327, all the gases are turned off and any particles, contamination, gases such as precursor-containing gas, carrier gas, inert gas, or plasma remained inside the processing chamber, are pumped out of the processing chamber for a desired period of time. In one example, the processing chamber is pumped out through the end of the process. In another example, the processing chamber is pumped out for about 1 second to about 2 minutes, such as about 10 seconds. Thereafter, the substrate is removed from the chamber.

One major advantage of the present invention is the defect reduction of multilayer deposition (e.g., DARC film) with a continuous plasma during and after the deposition of multiple layers of different thin films using plasma CVD processing. By maintaining the plasma between each deposition, unwanted defects on the substrate is significantly reduced because (1) particles that are formed during the deposition, or any flake off of the surfaces of the processing chamber, are suspended in the plasma until the final layer is finished, preventing them from falling on the substrate; (2) any remaining particles can be convected and/or pumped out of the processing chamber after the deposition of the last layer and prior to extinguishing the plasma; and (3) reactive species present in non-stoichiometric and non-equilibrium concentrations can be completely reacted to form part of the film, instead of agglomerating to form particles that will fall on top of the substrate when the plasma is extinguished.

Although the embodiment described above employed two separate layers stacked directly or indirectly on top of each other, it is contemplated that the present invention is applicable to a deposition process involving more than two different layers in the same processing chamber as long as the precursor gas(es) used for the subsequent layer is chemistry compatible with the precursor gas(es) of the previous layer using a continuous plasma between the deposition of each layer.

While the foregoing is directed to embodiments of the present invention, other and further embodiments of the invention may be devised without departing from the basic scope thereof, and the scope thereof is determined by the claims that follow.

What is claimed is:

1. A method for processing a substrate disposed within a processing chamber, comprising:
exposing the substrate to a first gas mixture and an inert gas in the presence of a plasma to deposit a first material layer on the substrate;
terminating the first gas mixture when a desired thickness of the first material is achieved while maintaining the plasma and flowing only the inert gas; and
exposing the substrate to the inert gas and a second gas mixture that are compatible with the first gas mixture in the presence of the plasma to deposit a second material layer over the first material layer in the same processing chamber without moving the substrate, wherein the first material layer and the second material layer are different from each other.

2. The method of claim 1, further comprising stabilizing a process condition for the deposition of the second material prior to the deposition of the second material layer.

3. The method of claim 1, wherein the inert gas comprises argon or helium.

4. The method of claim 1, further comprises terminating the electric field while still flowing the inert gas after the second material layer is deposited.

5. The method of claim 4, further comprises terminating all the gases and pumping out any gas or plasma generated in the processing chamber.

6. The method of claim 1, wherein the first and second materials comprise a material selected from the group consisting of silicon nitride, silicon rich nitride, hydrogen rich silicon nitride, silicon oxide, silicon-rich oxide, silicon oxynitride, silicon-rich oxynitride, amorphous silicon, silicon carbide, carbon doped silicon oxide, oxygen or nitride doped silicon carbide, doped amorphous silicon, amorphous carbon, amorphous silicon or carbon (un-doped or doped with N, B, F, O), porous or densified version of all above materials.

7. The method of claim 1, wherein the first and second materials comprise a material selected from the group consisting of tetraethylorthosilicate (TEOS) based silicon oxide, boron and/or phosphous doped TEOS based silicon oxide, TEOS based undoped silicon oxide, and fluorine doped TEOS based silicon oxide.

8. The method of claim 1, wherein the plasma is provided at a power level between about 25 W and about 3000 W at a frequency of 13.56 MHz.

9. A method for processing a substrate disposed within a processing chamber, comprising:
providing a first gas mixture by flowing one or more precursor gases and an inert gas to the chamber;
applying an electric field to the gas mixture and heating the gas mixture to decompose the one or more precursor gases in the gas mixture to generate a plasma;
depositing the first material on the substrate until a desired thickness of the first material is achieved;
terminating at least one gas flow of the one or more precursor gases in the first gas mixture while still maintaining the plasma and flowing only the inert gas;
stabilizing a process condition for a second material within the processing chamber by adjusting parameters of at least one of pressure, electrode spacing, plasma power, gas flow ratio, total gas flow, chamber temperature, and substrate temperature;
providing a second gas mixture by flowing one or more precursor gases to the same processing chamber without moving the substrate; and
depositing over the first material a second material that is different from the first material.

10. The method of claim 9, further comprises stabilizing a process condition for the first material within the processing chamber prior to the application of the electric field.

11. The method of claim 10, wherein stabilizing the processing condition comprises adjusting parameters of at least one of pressure, electrode spacing, plasma power, gas flow ratio, total gas flow, chamber temperature, and substrate temperature.

12. The method of claim 9, further comprises terminating the one or more precursor gases after a desired thickness of the second material is deposited while still flowing the inert gas to the processing chamber.

13. The method of claim 12, further comprises terminating the electric field while still flowing the inert gas prior to pumping out any gas or plasma generated in the processing chamber.

14. The method of claim 12, further comprises terminating the inert gas and pumping out any gas or plasma generated in the processing chamber prior to terminating the electric field.

15. The method of claim 9, wherein the first gas mixture and the second gas mixture are compatible to each other.

16. The method of claim 15, wherein the first and second materials comprise a material selected from the group consisting of silicon nitride, silicon rich nitride, hydrogen rich silicon nitride, silicon oxide, silicon-rich oxide, silicon oxynitride, silicon-rich oxynitride, amorphous silicon, silicon carbide, carbon doped silicon oxide, oxygen or nitride doped silicon carbide, doped amorphous silicon, amorphous carbon, amorphous silicon or carbon (un-doped or doped with N, B, F, O), porous or densified version of all above materials.

17. The method of claim 15, wherein the first and second materials comprise a material selected from the group consisting of tetraethylorthosilicate (TEOS) based silicon oxide, boron and/or phosphous doped TEOS based silicon oxide, TEOS based undoped silicon oxide, and fluorine doped TEOS based silicon oxide.

18. A method for reducing defects during multi-layer deposition within a processing chamber, comprising:
exposing the substrate to a first gas mixture and an inert gas in the presence of a plasma to deposit a first material layer on the substrate;
terminating the first gas mixture while still continuously igniting the plasma;
stabilizing a processing condition within the processing chamber;
exposing the substrate to a second gas mixture that is compatible with the first gas mixture in the presence of the plasma to deposit a second material layer over the first material layer in the same processing chamber; and
terminating the second gas mixture and pumping out any gas or plasma generated in the processing chamber.

19. The method of claim 18, wherein the inert gas is the only gas flowing in between the first material layer deposition and the second material layer deposition.

20. The method of claim 19, wherein the plasma is extinguished while still flowing the inert gas after the second material layer is deposited.
